(19) United States
(12) Patent Application Publication
(10) Pub. No.: US 2008/0295657 A1
(43) Pub. Date: Dec. 4, 2008

(54) RATCHET WITH STORAGE IN HANDLE

(75) Inventor: Gary Paul CLUTHE, Waterloo (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: DURON PLASTICS LIMITED, Waterloo (CA)

(21) Appl. No.: 11/757,449

(22) Filed: Jun. 4, 2007

(51) Int. Cl. B25G 1/08

(52) U.S. Cl. 81/490

(57) ABSTRACT

A storage rack pivots outwardly from a corresponding longitudinal recess in the handle of the tool. The storage rack accommodates tool accessories or the like, such as sockets where the tool is a ratchet. The storage rack has an outer surface which defines part of the handle when the storage rack is closed. Alternatively, there could be several storage racks each with different pivot points, or two racks pivoting in opposite directions and sharing a common pivot point. Preferably, the handle is of plastic, and in the case of a ratchet, is overmolded onto a metal ratchet mechanism. The ratchet mechanism has an irregular external shape, or splines or the like, to accept torque without slipping or separating from the plastic handle portion.

### BACKGROUND OF THE INVENTION

1. Field of the Invention

This invention relates to hand tools, and in particular to a ratchet or socket wrench handle or the like, having storage for sockets or other accessories in the handle of the tool.

2. Description of the Prior Art

Tool handles having storage areas are known. For example, U.S. Pat. No. 6,349,623 (Peters) shows a socket wrench with sockets stored in a tapered tray which slides into the end of the handle axially.

Similarly, U.S. Pat. No. 6,634,262 (Malchus) shows a socket tray which is screwed into the end of the handle axially.

Another example is U.S. Pat. No. 6,684,738 (Huang), which shows sockets nested axially in the handle.

Finally, U.S. patent application Ser. No. 10/791,508 (Peters; publication no. US 2004/0177733) again shows sockets nested axially in the handle.

Notwithstanding these prior art solutions, there is constant demand and need for new and inventive tools having unique storage means.

### SUMMARY OF THE INVENTION

It is an object of this invention to provide an improved storage means in the handle of hand tools, including but not limited to ratchet or socket wrench handles.

According to one aspect of the invention, a storage rack pivots outwardly from a corresponding longitudinal recess in the handle. The storage rack has means for accommodating tool accessories or the like, and an outer surface which defines part of the handle when the storage rack is closed.

In a preferred embodiment, the pivot point for the storage rack is adjacent the proximal end of the handle of the tool, but it could be located elsewhere, for example towards the distal end of the handle, or there could be several storage racks each with different pivot points, or possibly two racks pivoting in opposite directions and sharing a common pivot point.

In a preferred embodiment of the invention, the handle is of plastic, and is overmolded onto a metal ratchet mechanism. The ratchet mechanism has an irregular external shape, or splines or the like, to accept torque without slipping or separating from the plastic handle portion.

Further details of the invention will be described or will become apparent in the course of the following detailed description and drawings of specific embodiments of the invention, as examples.

### BRIEF DESCRIPTION OF THE DRAWINGS

Embodiments of the invention will now be described, by way of example only, with reference to the attached drawings, in which:

FIG. 1 is a perspective view of a preferred embodiment, showing the storage rack partially open, containing sockets and an extension;

FIG. 2 is a corresponding top view;

FIG. 3 is a top view with the storage rack closed;

FIG. 4 is a side view with the storage rack closed;

FIG. 5 is a perspective view showing the storage rack partially open, containing no tool elements;

FIG. 6 is a perspective view of a first example of a variation of the invention;

FIG. 7 is a perspective view of a second example of a variation of the invention; and

FIG. 8 is a perspective view of a third example of a variation of the invention.

### DETAILED DESCRIPTION OF THE INVENTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

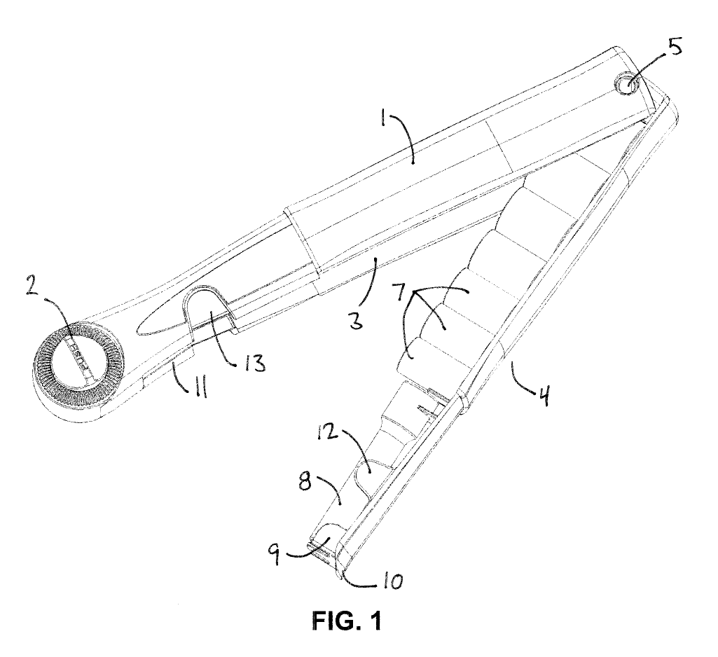

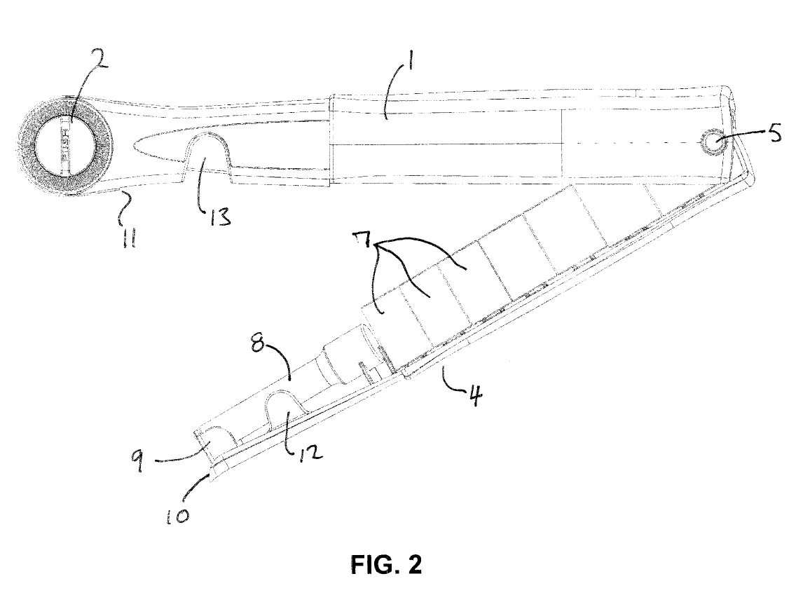

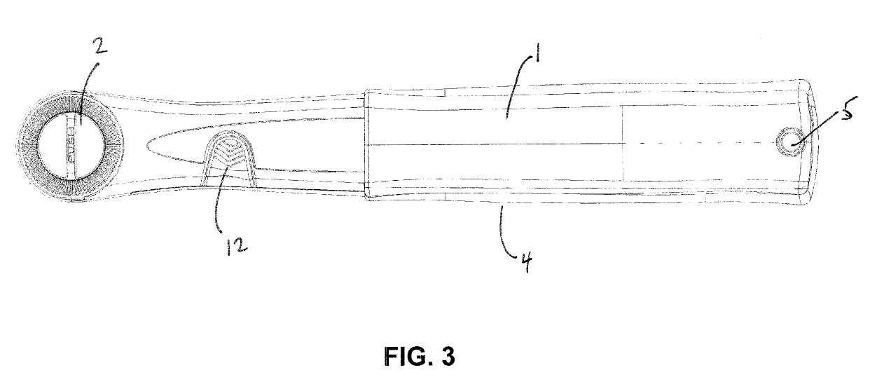

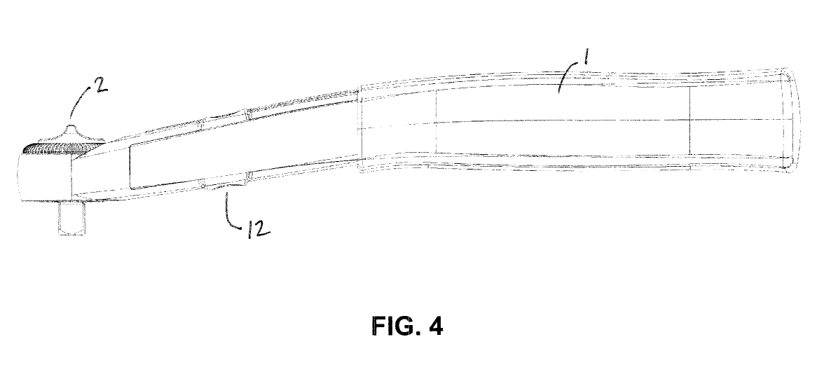

A preferred or exemplary embodiment of the invention is illustrated in FIGS. 1-5.

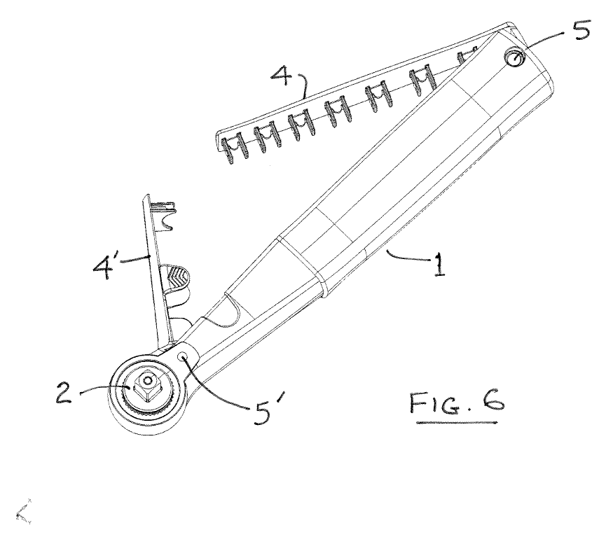

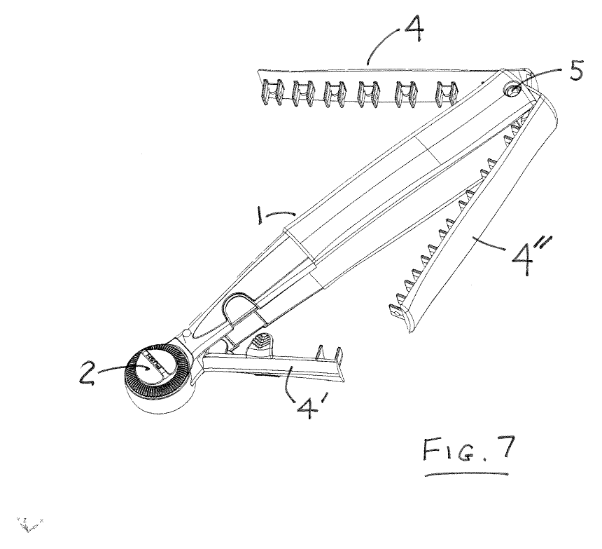

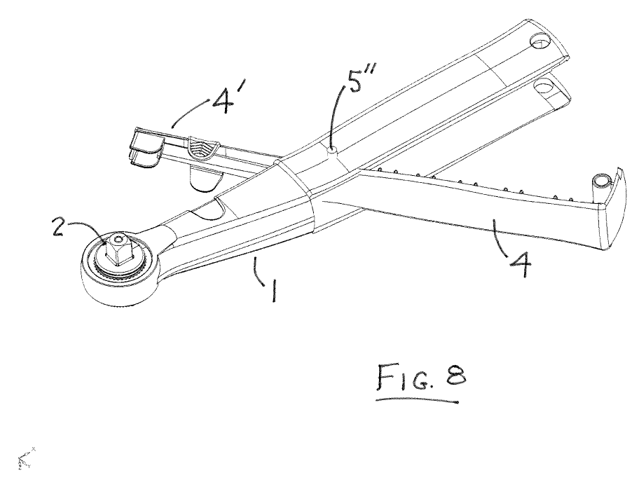

FIG. 1 shows a handle body 1 overmolded onto a ratchet mechanism 2 at the distal end of the handle body. The handle body has a longitudinal recess 3 therein, accommodating a storage rack 4 which is pivotally mounted in the handle body. In the preferred embodiment, the pivot pin 5 for this pivotal mounting is adjacent the proximal end of the handle. However, as mentioned above, it could be at the distal end (see FIG. 6 for an example), or there could be several storage racks and several pivot pins (see FIG. 7 for an example), or there could be a central pivot pin with two storage racks pivoting in opposite directions and sharing a common pivot point, either as separate racks, or two integral racks such that one opens when the other does, but in opposite directions (see FIG. 8 for an example).

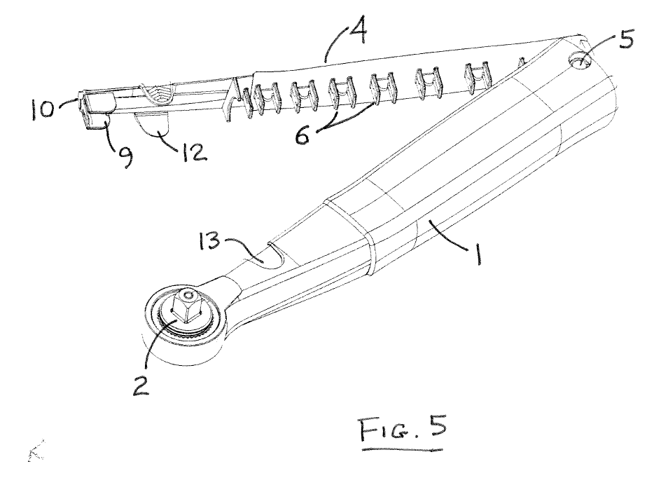

In the preferred embodiment, the storage rack has a number of flexible mounts 6 (see FIG. 5) or other mounting means to receive a number of sockets 7 for use with the ratchet. The flexible nature of the mounts, along with being suitably fitted to the dimensions of the socket drive hole, ensures that the sockets do not fall out when the storage rack is opened. Of course they should not be so tight as to be difficult to remove, and of course any other suitable means could be used, such as slightly flexible or resilient recesses corresponding to the external dimensions of the sockets (having the added advantage of ensuring that the sockets are correctly arranged in sequence according to size), or resilient stubs, or other suitable retention means.

As illustrated, the storage rack may also accommodate a small extension 8, carried axially and again secured by flexible clips 9 or any other suitable means.

A simple catch, for example a dimple 10 and recess 11 at the distal end of the storage rack, is used to keep the storage rack normally closed. Finger grips 12 fitting in corresponding recesses 13 are provided to easily grasp the storage rack and disengage it from the catch. Of course any other suitable closure means could be used.

As an example of one variation, FIG. 6 shows a small storage rack 4′ at the distal end of the handle, on a pivot pin 5′. Of course, there could be just one larger storage rack as in the preferred embodiment, but pivoted from the distal end instead of the proximal end.

FIGS. 6 and 7 both show more than one storage rack and several pivot pins. FIG. 7 is similar to FIG. 6, but shows two large storage racks 4 and 4″ along with the smaller storage rack 4′.

FIG. 8 shows yet another example, where there is a central pivot pin 5″ with two storage racks 4 and 4′ pivoting in opposite directions and sharing a common pivot point. As indicated previously, these could be separate racks, i.e. operating independently, or two integral racks as shown, such that one opens when the other does, but in opposite directions.

Preferably, but not necessarily, the handle is of plastic, and is overmolded onto the metal ratchet mechanism. The ratchet mechanism has an irregular external shape, or splines or the like, to accept torque without slipping or separating from the plastic handle portion. This aspect is not specifically illustrated, but will be readily understood by persons having ordinary skill in the field of the invention.

Preferred and exemplary embodiments of this invention are described herein. Variations of those embodiments may become apparent to those of ordinary skill in the art upon reading the foregoing description. It is expected that skilled persons will employ such variations as appropriate, and it is expected that the invention may be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Without limiting the generality of the foregoing, it should be noted in particular that the invention can be applied to tools other than ratchets or socket wrench sets. The invention can be applied to any hand tool having an elongated handle, where it is advantageous to store accessories in the tool handle. As just one specific further example, a screwdriver or the like could have a storage rack according to the invention, with various screwdriver bits stored therein.

1. A hand tool having an elongated handle body, and at least two storage racks longitudinally mounted in a corresponding recess in said handle body, pivotable from a closed position wherein an outer surface of said at least two storage racks cooperates with said handle body to define a handle for the tool, and an open position wherein said at least two storage racks extend outwardly from said handle body, exposing accessory storage means on said at least two storage racks;
wherein at least two of the said at least two storage racks pivot from a common pivot point.

2. A hand tool as in claim 1, wherein the common pivot point is adjacent a proximal end of said handle body.

3. (canceled)

4. (canceled)

5. (canceled)

6. (canceled)

7. A hand tool as in claim 1, wherein said common pivot point is generally centrally located in said handle body, and wherein said two storage racks are integral, such that one pivots outwardly from said handle body in one direction when the other pivots outwardly in the opposite direction.

8. A hand tool as in claim 1, where the hand tool is a ratchet, where the handle body is made of plastic and is overmolded onto a metal ratchet mechanism, and where at least one of the at least two storage racks has storage means to receive sockets configured for mounting on said ratchet mechanism.

9. A hand tool as in claim 2, where the hand tool is a ratchet, where the handle body is made of plastic and is overmolded onto a metal ratchet mechanism, and where at least one of the at least two storage racks has storage means to receive sockets configured for mounting on said ratchet mechanism.

10. (canceled)

11. (canceled)

12. (canceled)

13. (canceled)

14. A hand tool as in claim 7, where the hand tool is a ratchet, where the handle body is made of plastic and is overmolded onto a metal ratchet mechanism, and where at least one of the at least two storage racks has storage means to receive sockets configured for mounting on said ratchet mechanism.

15. A hand tool as in claim 1 further comprising a third storage rack.

16. A hand tool as in claim 15 wherein the third storage rack has a different pivot point from the common pivot point.

17. A hand tool having an elongated handle body, and at least two storage racks longitudinally mounted in a corresponding recess in said handle body, pivotable from a closed position wherein an outer surface of said at least two storage racks cooperate with said handle body to define a handle for the tool, and an open position wherein said at least two storage racks extends outwardly from said handle body, exposing accessory storage means on said at least two storage racks;
wherein the at least two storage racks pivot from different pivot points, the different pivot points being located along a longitudinal axis of the hand tool.
